(19) United States
(12) Patent Application Publication
(10) Pub. No.: US 2015/0278475 A1
(43) Pub. Date: Oct. 1, 2015

(54) SOCIAL MEDICATION MANAGEMENT WITH SENSORS

(71) Applicant: MediSafe Project LTD., Nofit (IL)

(72) Inventor: Omri SHOR, Nofit (IL)

(21) Appl. No.: 14/671,338

(22) Filed: Mar. 27, 2015

Related U.S. Application Data
(60) Provisional application No. 61/972,624, filed on Mar. 31, 2014.

(51) Int. Cl. G06F 19/00; G06Q 50/00

(52) U.S. Cl. CPC G06F 19/3456; G06Q 50/01

(57) ABSTRACT

A system, method and platform are herein provided for enabling social medication adherence enhancement. According to one embodiment a system or platform is provided for socially supporting medication adherence management, comprising a user application for managing medication adherence; a data server with memory thereon for storing medication adherence related data; a web server running code to enable social medication adherence tracking, by sharing user application data with a selected social group; and one or more of sensors for tracking medication adherence related stimuli and cross-checking medication data with data generated from sensors to inform users.

### CROSS REFERENCE TO RELATED APPLICATIONS

This application claims priority from U.S. Provisional Patent Application No. 61/972,624, filed 31 Mar. 2014, entitled “MEDICATION MANAGEMENT WITH SENSORS”, which is incorporated in its entirety herein by reference.

### BACKGROUND OF THE INVENTION

Medication or drug adherence (sometimes also referred to as compliance) describes the degree to which a patient correctly follows medication instructions. Both the patient and the healthcare provider affect adherence, and a positive physician-patient relationship is an important factor in improving adherence.

Worldwide, non-adherence is a major obstacle to the effective delivery of healthcare. Estimates from the World Health Organization (2003) indicate that only about 50% of patients with chronic diseases living in developed countries follow treatment recommendations. Adherence rates may be overestimated in the medical literature, as adherence is often high in the setting of a formal clinical trial but drops off in a “real-world” setting.

Major barriers to adherence are thought to include the complexity of modern medication regimens, poor “health literacy” and lack of comprehension of treatment benefits, the occurrence of undiscussed side effects, the cost of prescription medicine, and poor communication or lack of trust between the patient and his or her health-care provider. Efforts to improve adherence have been aimed at simplifying medication packaging, providing effective medication reminders, improving patient education, and limiting the number of medications prescribed simultaneously.

It would be highly advantageous to have a system, platform or method that could enable medication takers to be helped to take medications on time, and to be better monitored and supported.

### SUMMARY OF THE INVENTION

There is provided, in accordance with an embodiment of the present invention, a platform, system and method for enhanced social medication adherence.

A system, method and platform are herein provided for enabling social medication adherence enhancement. According to one embodiment a system or platform is provided for socially supporting medication adherence management, comprising a user application for managing medication adherence; a data server with memory thereon for storing medication adherence related data; a web server running code to enable social medication adherence tracking, by sharing user application data with a selected social group; and one or more of sensors for tracking medication adherence related data.

In some embodiments, the sensors are physiological sensors used for tracking user physiological factors and/or changes, for example, for measuring one or more of heart rate, brain control interfaces, blood pressure, skin temperature, perspiration, activity pattern, sleep patterns, weight, blood glucose level, Oxygen saturation level, moods or hormonal measurements, and medication measurements.

In some embodiments, the sensors are physiological sensors used for tracking environmental factors and/or changes, for example, acoustic, sound, and vibration sensors; automotive and transportation sensors; chemical sensors; electric current, electric potential, magnetic, and radio sensors; flow and fluid velocity sensors; navigation instruments; position, angle, displacement, distance, speed, and acceleration sensors; optical, light, imaging, and photon sensors; pressure sensors; force, density, and level sensors; thermal, heat, and temperature sensors; and proximity and presence sensors.

In some embodiments, the medication adherence data includes one or more of medication data, user behavior data, physiological data, biometric data, and environment data.

In some embodiments, the platform may include computer code for cross checking medication adherence data, user physiological data and/or environmental data, to help monitor and/or track medication adherence.

In some embodiments, the platform may include computer code for cross checking medication adherence data, user physiological data and/or environmental data, to help monitor and/or track medication efficacy.

In further embodiments, the medication adherence system may further include computer code for enabling the personalization of system communications based on personal criteria, personal behavior tracking, physiological data sensing and/or environmental sensing.

In additional embodiments, the medication adherence system may further include personal user behavior tracking, optionally integrating medication related gesture tracking based on one or more user movement sensors.

In still further embodiments, the medication adherence system may further include predictive algorithms to enable enhanced alerting of users based on predictions of likely non-adherence.

According to some embodiments, a platform for social medication management is herein provided, which may include: a social media enabled website and medicine adherence services with social media network functionality; a mobile computing device enabled with a medication management application including a virtual pill box, the mobile device being connected to one or more sensors for tracking medication adherence related data; a medication adherence database; and a group management portal for enabling user medication management data with a selected social group.

In some embodiments the platform may further comprise connectivity to one or more third party modules.

In some embodiments the platform may further comprise a data security module.

In some embodiments the platform may further comprise a group alert module for alerting a selected social group of an event.

In some embodiments the platform may further comprise connectivity to one or more third party modules.

In some embodiments the platform may further comprise a gesture tracking module and one or more movement sensors.

According to some embodiments, a method is provided for enabling social medication adherence management, comprising: installing a medication adherence application to a mobile communications device, where the medication adherence application is enabled to display and operate a virtual pill box; communicatively connecting the medication adherence application to a medication adherence management platform; setting up a social group connected to a user via the platform, to help monitor user medication adherence; adding user medication adherence data into the platform, via the application, wherein the user medication adherence data includes data from one or more sensors communicatively connected to the communications device; and tracking medication adherence of a user, by the social group.

In some embodiments, the method may further comprise synchronizing user medication adherence data between the social group.

In some embodiments, the method may further comprise cross checking medication data on the medication adherence management platform with user medication adherence data from the medication adherence application.

In some embodiments, the method may further comprise automatically tracking user movement to identify medication adherence behavior.

### BRIEF DESCRIPTION OF THE DRAWINGS

The principles and operation of the system, apparatus, and method according to the present invention may be better understood with reference to the drawings, and the following description, it being understood that these drawings are given for illustrative purposes only and are not meant to be limiting, wherein:

FIGS. 1A and 1B are schematic system diagrams depicting critical elements of a social medication management system, according to some embodiments;

FIG. 2 is a schematic system diagram depicting components of a social medication management system, according to some embodiments;

FIG. 3 is a flow diagram indicating an example of a process by which a medication adherence application operates, in cooperation with the medication adherence system, according to some embodiments;

FIG. 4 is a flow diagram indicating an example of a process by which medication intake may be managed, in cooperation with the medication adherence system, according to some embodiments; and

FIG. 5 is a flow diagram depicting a process of implementing Third Party Sensor Connectivity within the medication adherence system, according to some embodiments.

### DETAILED DESCRIPTION OF THE INVENTION

The following description is presented to enable one of ordinary skill in the art to make and use the invention as provided in the context of a particular application and its requirements. Various modifications to the described embodiments will be apparent to those with skill in the art, and the general principles defined herein may be applied to other embodiments. Therefore, the present invention is not intended to be limited to the particular embodiments shown and described, but is to be accorded the widest scope consistent with the principles and novel features herein disclosed. In other instances, well-known methods, procedures, and components have not been described in detail so as not to obscure the present invention.

As used herein, the term “social” may include a group, club, or community of one or more people. The term “social group” may include individuals or organizations, including friends, family, support groups, support staff, medical practitioners, medical centers, laboratories, pharmacies etc. As used herein, the term “physiological sensor” may include biological sensors or any sensors that may be worn, held or otherwise borne or carried. Further, the term “physiological sensors” may be further used to also describe body integrated or implanted sensors (for example, sensors worn on clothing, straps, watches, etc.), as well as sensors that can be integrated or otherwise applied in conjunction with a remote computing or communications device, such as a smart phone, tablet, smart watch or other device often carried around by a user, which integrates and/or facilitates usage of multiple sensors. As used herein, the term “physiological” measurements may refer to measurement of any physical, biological, biometric, or other characteristic of the normal functioning of a living organism. As used herein, the term “environmental sensor” may include any sensors that measure environmental data, including, for example, weather, moisture, temperature, light, humidity, altitude, location sensors, or other sensors adapted to measure relevant environment data.

According to some embodiments of the present invention, a system, platform and methods are provided for providing social medication adherence management. In some embodiments automated registration of medications is enabled, using online and/or conventional mail/phone registration of medications.

In some embodiments, social medication adherence management and control includes a social support feature, whereby a group, such as a family, may be communicatively connected to a medication taker, to receive alerts, updates, enable multi-way communications etc. to further enhance medication adherence and reduce mistakes in medication adherence.

Non-limiting embodiments of the present invention include a system, method and/or means for facilitating enhanced medication adherence or adherence management. In some embodiments, systems and methods are provided for facilitating user adherence, by integration with physiological and/or environmental sensors, and by cross checking one or more sources of data that may be related to medication adherence, hereinafter referred to as medication adherence data, used to monitor, track, control or otherwise manage medication adherence and/or efficacy. As referred to hereinafter, medication adherence data may include, for example, one or more of medication data, user behavior data, physiological data, biometric data, and environment data.

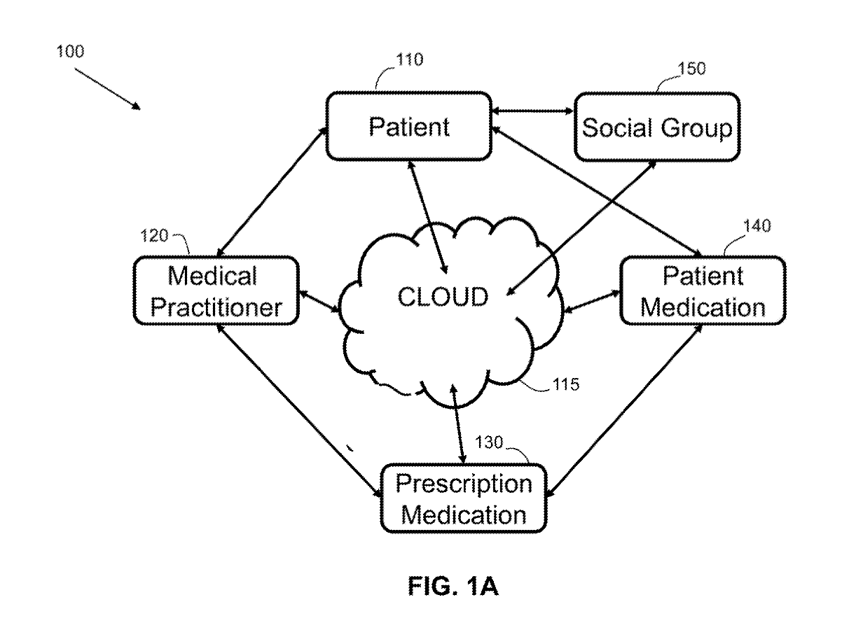

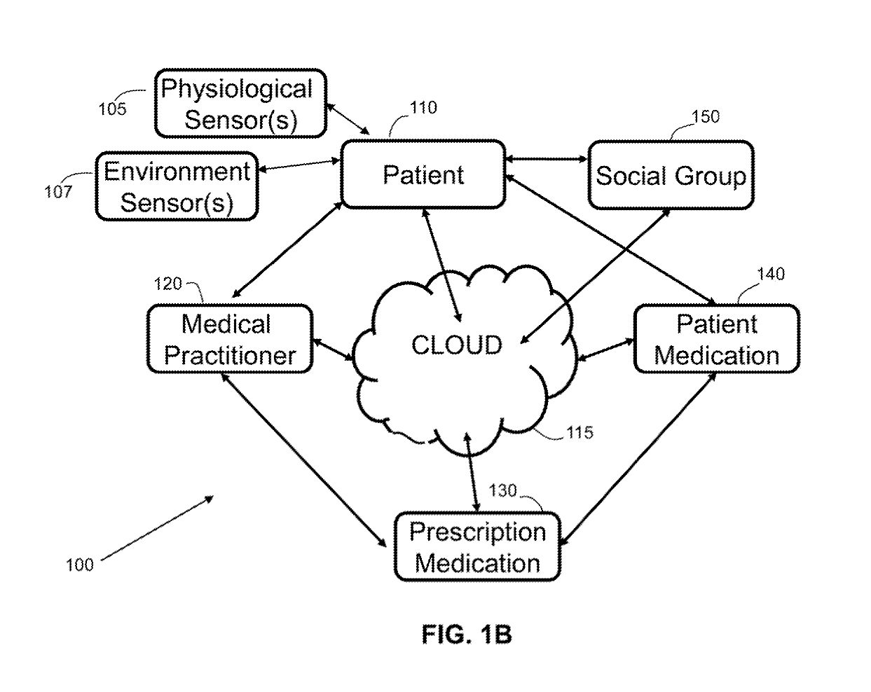

FIG. 1A is a schematic system diagram depicting critical elements of a social patient medication environment 100, according to some embodiments. As can be seen in FIG. 1A, typical patient medication environment includes the patient 110, medical practitioner or organization 120, the prescription medication 130, instructed by the practitioner 120, and the actual patient medication 140, which patient 110 is supposed to take in the correct or optimal way. In some embodiments, the medication adherence loop may further include a social group or family 150, to support the patient 110, which is a significant addition to the typical patient medication environment. The family or another selected group 150 may be included in communications, alerts, and updates etc. that relate to a patient in the social medication adherence system. The social group may include individuals or organizations connected to the user, for example, medical practitioners, data centers, medical centers, pharmacists, support groups, family, friends etc.

FIG. 1B is a schematic system diagram depicting critical elements of a patient medication environment 100, according to some embodiments, wherein physiological sensors 105 may be integrated. As referred to herein, physiological sensors, sometimes referred to as wearable sensors, may include sensors worn on clothing, straps, watches, on the skin, carried by a user, implanted in a user, or otherwise remotely connected to a user, to sense or measure physiological, behavioral or biometric data. For example, physiological sensors may include one or more sensors monitoring heart rate measurement, Brain Control Interfaces (BCI), Blood pressure, Skin temperature, Perspiration, Activity pattern (e.g., steps, activity type etc.), Sleep patterns (e.g., sleep duration, awakenings, sleep phases—deep, light, REM etc.), Weight, Blood glucose level, Oxygen saturation level, Moods or hormonal measurements, medication or other Concentration measurements etc.

Further, in some embodiments, environmental sensors 107 may be integrated, to measure environmental data such as weather, moisture, temperature, light, humidity, altitude, location, etc. In some examples, environmental sensors may include: acoustic, sound, and vibration sensors; automotive and transportation sensors; Chemical sensors; Electric current, electric potential, magnetic, and radio sensors; Flow and fluid velocity sensors; Navigation instruments; Position, angle, displacement, distance, speed, and acceleration sensors; Optical, light, imaging, and photon sensors; Pressure sensors; Force, density, and level sensors; Thermal, heat, and temperature sensors; Proximity and presence sensors; and other suitable sensors.

As can be seen in FIG. 1B, relevant physiological, behavioral, biometric and/or environmental data may be collected from the patient from one or more system, platform and/or third party sensors or other sources. This data may reflect the effect of medication usage or the lack thereof on a patient, and may subsequently be cross checked with a patient's medication information, profile or needs to help determine medication adherence, and the effect of the medication on the individual's physiology.

In accordance with some embodiments, sensors of many kinds may be used to measure user metrics of many types. The sensor data may be matched against the medication being used by the patient or user, and the combined data may be further analyzed or processed to enable alerts, recommendations and further personalized health support. For example, Medication information entered into the system may include one or more of: Medication name, Dosage, Time taken, whether they are Generic or Ethic medicines, Adherence pattern, Consumption duration, etc. In further examples the sensor(s) may be used to measure one or more physiological signs or signals including: Heart rate, Skin temperature, Perspiration, Activity pattern (e.g., steps, activity type etc.), Sleep patterns (e.g., sleep duration, awakenings, sleep phases—deep, light, REM etc.), Weight, Blood pressure, Blood glucose level, Oxygen saturation level, Moods or hormonal measurements, medication or other Concentration measurements etc.

In accordance with some embodiments, system generated recommendations resulting from the data analysis described above may include one or more of: optimal consumption time(s), Dosage change alerts, Change drug alerts, Drug efficacy alerts, Generic vs. Ethic drug efficacy recommendations, Drug effect on physiologic variables and life habits, such as sleep, activity, mood, concentration etc. Of course, other alerts, notifications and/or recommendations may be generated, as required.

As described herein, the integration of physiological sensors and/or environmental sensors, whether wearable and/or other sensors, may help understand the effect of medication adherence on a user's health, psychology and life habits etc., and allow the system, platform and methods described herein to aid users in enhancing their medication adherence.

Furthermore, in some embodiments, analysis of data from physiological and/or environmental sensors may enable generation of substantially real time alerts, in-depth long-term recommendations, patient periodic health tracking etc., thus enabling an enhanced real-life personalized medicine approach, by using the system, platform and methods described herein to aid users in enhancing their medication adherence.

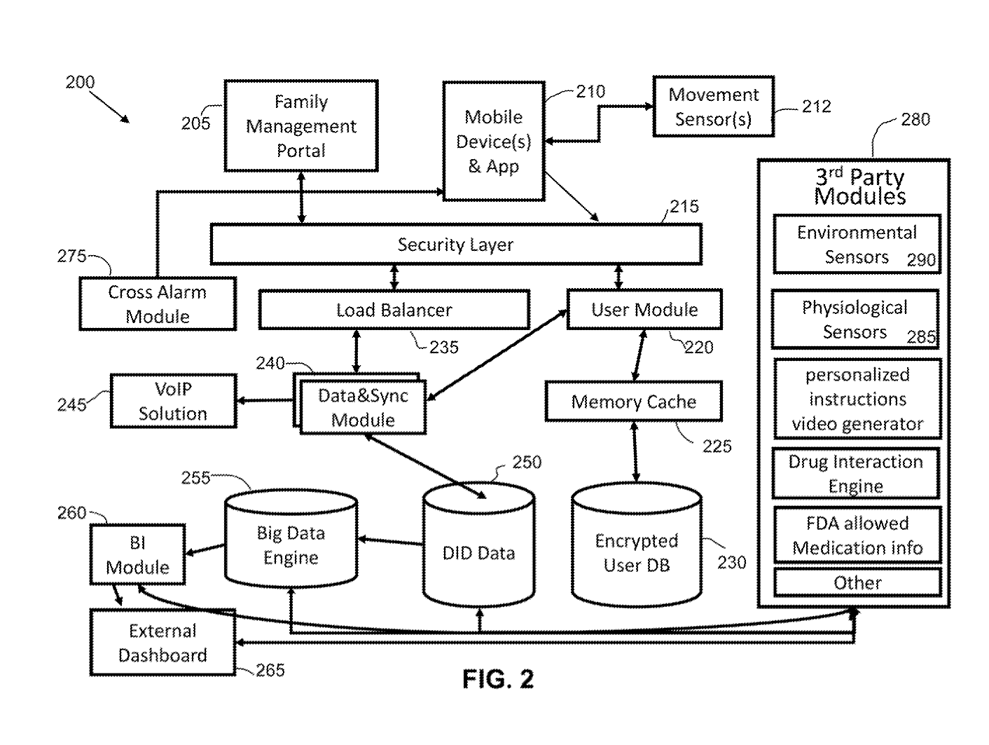

FIG. 2 is a schematic system diagram depicting components of a medication management platform 200, for enabling user download and usage, according to some embodiments. As can be seen in FIG. 2, a group user interface is provided, such as a family management portal 205, and a mobile or smart device with a medication management Application (App) 210, optionally connected to or integrating one or more movement sensors 212, is provided for access to the portal 205 from substantially any connected device, for example smart pillboxes. User access is generally channeled through a security layer 215 to ensure user authentication, permissions, and access to data. In general a user makes use of a User Module 220 to access user data, optionally from memory cache 225, and generally as stored on encrypted user Database 230. User Module 220 may be connected to a Data and Sync Module 240, to keep data updated and synchronized for users, optionally using a VoIP solution 245, or other secure data interface. Data and Sync Module 240 may also be in connection with a load balancer 235, to help stabilize and secure data transfers. In some embodiments, a cross Alarm module 275 may also be provided, for example, for connecting system users to other system users, which may hereinafter defined as a medication adherence friend, to enable mutual notifications and alerts etc. Data and Sync Module 240 may also be communicatively connected to a De-Identified data (DID) storage, which is in communication with a Big Data Engine 255, for example a cross-platform document-oriented database system such as Mongo DB. Big Data Engine 255 may be in communication with a Business Intelligence module 260. In some examples an external control dashboard 265 may be provided, for example a Pharma data analytics dashboard, or other selected dashboard for a specialized or generic segment or space. In general, one or more system components described above may include a file(s) with running a program or set of instructions to execute commands to enable execution of medication adherence related enhancements. In some embodiments, 3^{rd} Party modules 280 may be communicatively connected to and/or integrated into one or more 3^{rd} party system modules. For example, video generators for personal instructions, drug interaction engines, FDA medication information systems, physiological sensors 285, and/or environmental sensors 290 etc. may be in communication with DID data module 250, Big Data Engine 255, BI Module 260 and Control Dashboard 265 etc. In some embodiments a Queue server may be integrated into the system, to enable smart queuing of data processing and communications. In other embodiments a transaction server may be integrated into the system, to facilitate user transactions, and optionally payment based transactions.

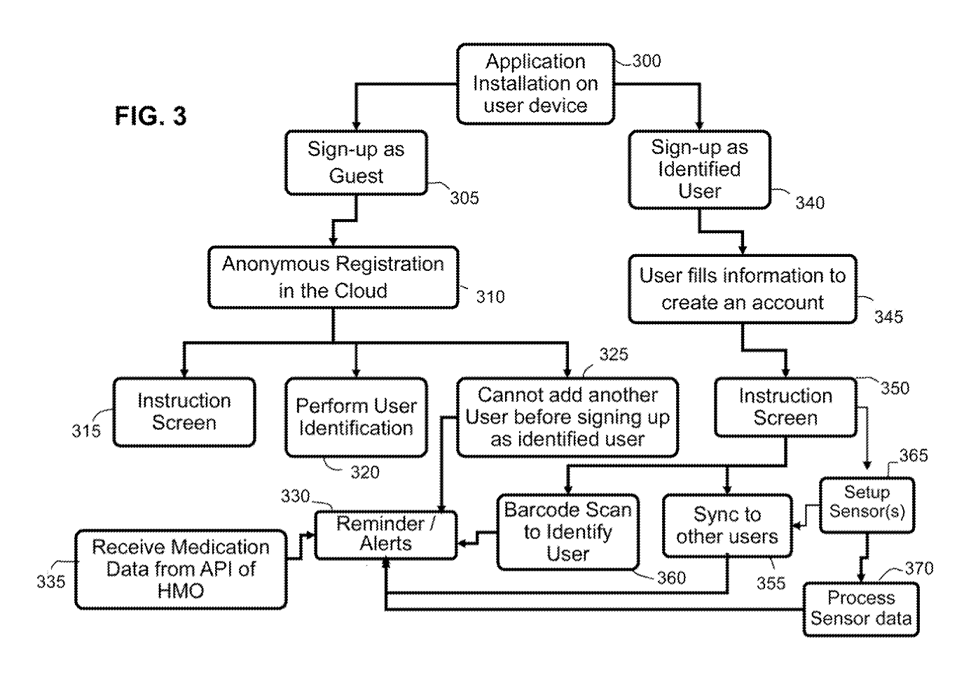

FIG. 3 is a flow diagram indicating an example of a process by which a medication adherence application or program operates, in cooperation with the medication adherence system, according to some embodiments. As can be seen in FIG. 3, at step 300 a user may install an application or interface code on a user device, for example a mobile communications or computing device. At step 305 the user may sign up, optionally as a guest, in which case they may at step 310 anonymously register on the cloud/Website. Typically the user may be provided at step 315 with an instruction screen. At step 320 the user may be identified, for example using a scanning or identification step, for example, a bar code scan. Generally a user will need to register before being allowed to add another user, at step 325.

At step 340 a user can sign up as a member or identified user. At step 345 the user may fill in user information to open an account. At step 350 the user may make use of an instruction screen(s) and optionally use a scanning or identification option, for example, a bar code scan, at step 360. At step 355 an identified user may be able to sync or connect with other users. At step 365 a user may connect one or more sensors, whether internal or external to the user device, to provide data to the medication adherence platform or application, the data from which is processed, at step 370, to enable further medication adherence services. For example, the data may be analyzed, and presented alongside medication data, to keep users informed. In any case, whether the user is identified or anonymous, the user may initiate and/or be in receipt of alerts, updates and/or reminders, at step 330. Additionally, at step 335, the users may be in receipt of reminders, updates or alerts initiated by medical practitioners or organizations, for example, such as medication data alerts generated by an API of an HMO, hospital, practitioner, pharmacy, medication tracking company (e.g. Medisafe Ltd.) etc. Of course, other steps or combination of steps may be used.

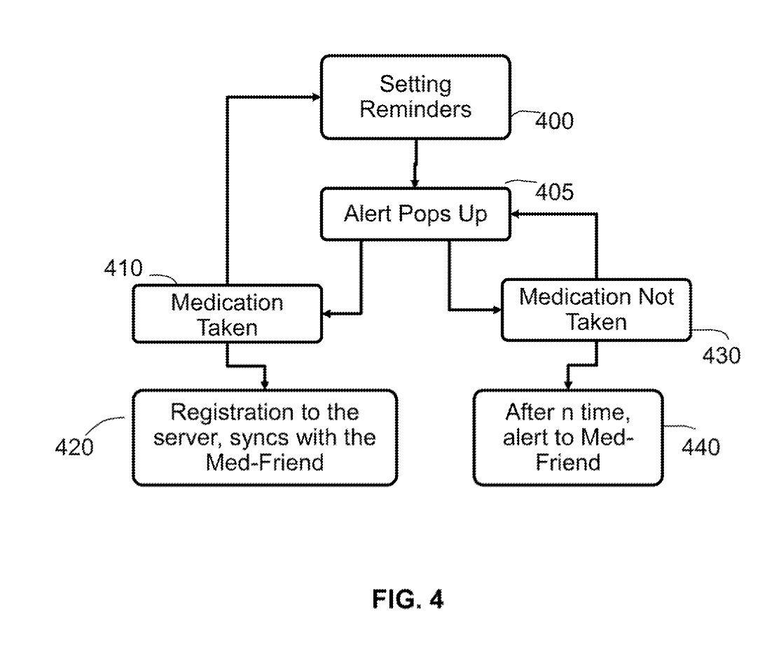

FIG. 4 is a flow diagram indicating the process by which a medication adherence is managed, in cooperation with the medication adherence system, according to some embodiments. As can be seen in FIG. 4, at step 400 reminders may be set, manually or automatically, whether by the medication instructor, distributer, patient and/or patient support group, or others in the medication adherence environment. At step 405 an alert, update, message etc. may be sent to the patient or other users of the system. Such alerts may be in the form of emails, instant messages, chats, or other relevant formats or types. In general the patient or patient support team may be requested by the alert to respond with an update. For example, at step 410, if the medication has been taken, a user may enter this fact, optionally in response to the alert, or independently of the alert. Such a data entry may then neutralize or otherwise change the status of the current alert, and may be used to manually or automatically reset the reminders settings, at step 400. In the case where, at step 430, medication has not been taken, for example, a user may enter this fact, optionally in response to the alert, or independently of the alert. In such a case, the alert may be recycled or re-activated, at step 440. For example, the alert may be sent immediately or at a selected time (n time) to the patient, to the patients support group, the patient's practitioner etc. In some embodiments one or more physiological sensors and/or environmental sensors may be used to help determine medication adherence, the data from which may be automatically, semi-automatically, or manually entered into the system. Of course, other steps or combination of steps may be used.

In accordance with some embodiments, mobile Apps may be developed for various platforms or operating systems. Apps may optionally use the scanning capabilities of remote mobile or computing devices. The medication adherence system described herein may include mobile application interfaces, desktop interfaces and point of contact (POC) terminals, may enable adherence management from receipt of instructions from a practitioner, through the purchase or acquisition of medication, and during execution or usage of the medications. The system may enable continual or periodical monitoring of medication adherence, and sending of messages such as alerts and updates, to help encourage enhanced medication taking, and preventing forgetfulness or other factors active in decreasing adherence. The application or interface may include usage of graphics, video, voice, scanning, positioning data, user movement data and more to aid medication adherence monitoring. Applications in some cases may be customized for selected populations, conditions, environments etc.

In some embodiments, an application for mobile computing or computing devices may include a virtual pill box representing the pills to be taken by a user during one or more time periods. In some examples the virtual pill box may enable the end user or the end user's social group to graphically view the pills to be taken over or in a period of time, as well as the pills that have been taken over or during a time period. In one example, the virtual pill box may have a graphic interface that may be divided into multiple segments or compartments, reflecting the medications that a user should take and/or has taken in multiple periods of the day. Optionally the time of the pill to be taken or that has been taken may be displayed in different fonts, colors, or with other effects to help alert the user or inform the user of medication taking adherence.

In some embodiments, a platform for social medication safety management is provided, which may include a social media enabled website and medicine adherence services with complete social media network functionality; a mobile computing device enabled with an medication management application including a virtual pill box; a group management portal; a medication adherence database; and connectivity to third party modules.

In further embodiments the platform may further include a data security module.

In still further embodiments the platform may include a group alert module for alerting a selected social group of an event.

In general, the system may be cloud based and scalable to be used with any number of users. Further, in some embodiments, a distributed computing platform may be used, to help enable the analysis and processing of large amounts of information accumulated substantially in real time, by using significant computing power to process data as necessary.

The system may use external data from, for example, HMO's, medical organizations, government data sources, online sources, personal medical records, personal location data etc. Further, the system may make use of data from social networks, and may facilitate formation of user profiles and/or groups or group profiles, for example, to allow building of a social network related to a medication, condition etc. For example, “objective” user data such as age, gender, race, etc. May be used to contribute to user profile setup, along with actual user behavior, user preferences etc.

In further embodiments, the system may analyze, optionally processing with artificial intelligence algorithms or other processing means, to create customized alerts, features, suggestions, predictions etc., to enhance the user experience. For example, the system may enable analyzing personal usage patterns, interests, needs, limitations etc., to provide interfaces, services, suggestions etc. to maximize user medication adherence and minimize the likelihood that a user will fail to take the medication.

In further embodiments, the medication adherence system may further include computer code for enabling the personalization of system communications based on personal criteria and/or personal behavior tracking analytics.

In additional embodiments, the medication adherence system may further include personal user behaviour tracking, optionally integrating medication administering gesture tracking based on a user movement sensor device. In still further embodiments, a method for enabling social medication adherence management may further comprise tracking user movement to identify medication adherence data, and automatically entering such data into the platform. For example, one or more sensors worn by a user, carried by a user or integrated into a user's computing or communications device may be used to track and process user movements, such as determining when a user moves their hand(s) to open a pill, take a pill, drink water, swallow a pill etc.

In still further embodiments, the medication adherence system may further include predictive algorithms to enable enhanced alerting of users based on predictions of likely non-adherence.

In still a further embodiment, businesses or organizations may use user adherence tracking to enable matching or processing of such data in combination with data from drug companies, distributors, manufacturers, pharmacies, hospitals, HMO's etc. Such data processing may aid statistical evaluations of past, current and/or future medication usage, as well as predictions for usage, health threats, etc. immediate alerts medication use.

In some embodiments data from the system may be used to deliver reports and/or process data to enable drug companies, distributors, manufacturers, hospitals, HMO's etc. to provide usage reports and predictions. Such data may help aid resource planning, production planning, health alert prediction etc.

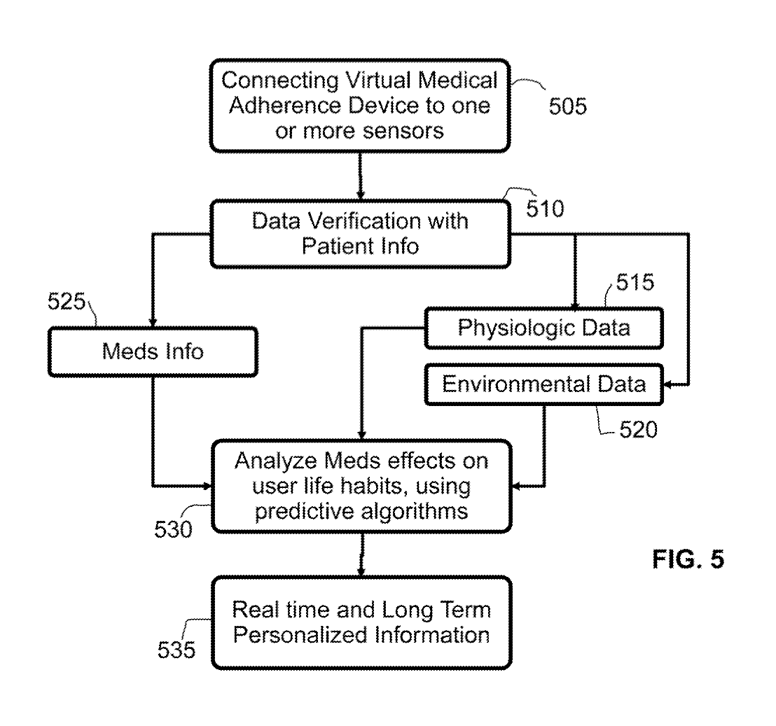

As can be seen with reference to FIG. 5, at step 505, an adherence device, for example a communications device or computing device with a medicinal adherence application or functionality (referred to herein as MediSafe™) may connect to one or more medication adherence related sensors, optionally 3^{rd} party's sensors. At step 510 the data received from the sensor(s) is verified, optionally with patient information. At step 515 physiological information may be sensed, for example, heart rate, skin temperature, blood pressure etc. may be acquired, from one or more physiological sensors. In further embodiments, at step 520, data from other sensors, such as environmental sensors, may be acquired, from one or more environmental sensors. At step 525 the relevant medication information may be entered into the system, by a user or by a medication manufacturer, supplier, or any other source. In some embodiments, the medication adherence data received to the adherence device may be checked against the received sensor data and/or medication data. For example, the name of medicine, dosage, time taken, adherence patterns etc. may be utilized. At step 530 one or more predictive algorithms may analyze the received data, to help determine the effect of the medication or lack thereof on a user's life habits. At step 535 the system, platform, device may make recommendations based on highly personalized analysis. Of course, other steps or combinations of steps may be used.

In accordance with some embodiments, the system may integrate usage of wearable or other body and/or environmental tracking devices to help enable enhanced adherence. Accordingly, the system may be configured to correlate with a user's communication or communication device(s) to help determine medication taking history and/or prediction of taking. For example, a user may make use of one or more wearable sensors, optionally integrated into their hand watch, communications device, clothing, carrier bag or other devices, and/or the user may make use of sensor(s) integrated into user computing or communications devices, to help determine adherence data. In some examples, the device sensor may function as a gesture monitor, for example to determine if and when a user has made a medication opening/preparation movement, intake movement etc. In still further embodiments specialized gestures related to medication adherence may be defined, monitored and tracked, to help determine user adherence optionally without relying on user data entry.

In accordance with additional embodiments, predictive analysis may be used to predict user medication adherence, and provide functionality enhancements in accordance. In some examples, user entered preferences and/or behavior tracking on various levels and or at various levels of resolution, may be used to predict likely medication taking or failure to take medicines. In one example, adherence prediction may be based on analysis of one or more of user location, time, activity, weather, and company etc., used to predict likelihood of taking medication. As a result, if a certain situation is assumed to create a likelihood of forgetfulness to take medication, then a higher level of alert may be initiated to encourage the user to take medication. Of course other factors or combination of factors may be used. In a further example, based on system data analysis, it has been established that users in a certain geographical area are less likely to take medications in the evenings on weekends, in which case further measures such as group alerts may be used at these times to encourage extra vigilance in medication taking at these times for users in these places. Of course, alerts or other smart events may be triggered by the system to compensate for increased likelihood of non-adherence.

In accordance with further embodiments of a medication adherence platform, the platform may integrate external physiological sensors and/or environmental sensors, for example, which may be on a mobile device, such a smart phone, smart watch, smart glasses, headgear, bags or other accessories or devices. In some embodiments a variety of sensors may be connected to through a port, cable or wirelessly to a smart phone or other communications or computing device, such as physiological, biometric and/or environment sensors, for example, for measurement of temperature, humidity, light, air pressure, sound, position, vital signs, blood pressure, breathing, heartbeat, movement, etc.

In accordance with additional embodiments, a medication adherence platform may integrate physiological sensors to enhance clinical trials, for example, by monitoring and tracking user responses to medication being tested.

In accordance with still further embodiments, a medication adherence platform may integrate physiological sensors to enhance drug impact studies or tracking. For example, data acquired from wearable or other sensors may enable monitoring of the effect of medication over time, with or without the user's active participation. Such functionality can enable medication adherence monitoring as well as efficacy testing or tracking. For example, if a user took one drug for reducing blood pressure and the physiological sensors show that the user's blood pressure goes down immediately, but another drug is showing a gradual decrease of blood pressure only 1 hour after the user takes it—this could be extremely important information. When such information is linked with other data that can be gathered, such as other drugs the user is taking, other physiological data, geo-location and weather data (e.g., if the user in a hot/cold zone of the world or in a high/low altitude area etc.), or other factors, the information gleaned may be of great importance. In another example, a user that is very sportive (active) might show different results from a certain drug compared with somebody that is not as active. In some cases the data about user activeness can be gathered either through wearable or mobile devices like smart phones, smart watches, or GPS timers.

In yet further embodiments, the medication adherence platform may run algorithms or code adapted to recognize and learn patterns and correlations between all these pieces of data, optionally automatically. Further the platform may be adapted to provide alerts and personalized recommendations, for example, to avoid potential detrimental effects to a user as it relates to taking or not taking a certain drug at a specific time, location or in relation to any other activity that person may be doing.

The foregoing description of the embodiments of the invention has been presented for the purposes of illustration and description. It is not intended to be exhaustive or to limit the invention to the precise form disclosed. It should be appreciated by persons skilled in the art that many modifications, variations, substitutions, changes, and equivalents are possible in light of the above teaching. It is, therefore, to be understood that the appended claims are intended to cover all such modifications and changes as fall within the true spirit of the invention.

What is claimed is:

1. A medication management system, comprising:
a user application for managing medication adherence;
a data server with memory thereon for storing medication adherence related data; and
a web server running code to enable social medication adherence tracking, by sharing user application data with a selected social group; and
one or more of sensors for tracking medication adherence related data.

2. The system of claim 1, wherein said sensors are physiological sensors for measuring one or more of heart rate, brain control interfaces, blood pressure, skin temperature, perspiration, activity pattern, sleep patterns, weight, blood glucose level, Oxygen saturation level, moods or hormonal measurements, and medication measurements.

3. The system of claim 2, wherein said sensors are environment sensors selected from the group consisting of acoustic, sound, and vibration sensors; automotive and transportation sensors; chemical sensors; electric current, electric potential, magnetic, and radio sensors; flow and fluid velocity sensors; navigation instruments; position, angle, displacement, distance, speed, and acceleration sensors; optical, light, imaging, and photon sensors; pressure sensors; force, density, and level sensors; thermal, heat, and temperature sensors; and proximity and presence sensors.

4. The system of claim 1, wherein the medication adherence data includes one or more of medication data, user behavior data, physiological data, biometric data, and environment data.

5. The system of claim 1, further including computer code for cross checking one or more of medication adherence data, user physiological data and environmental data, to help monitor medication adherence.

6. The system of claim 1, further including computer code for cross checking one or more of medication adherence data, user physiological data and environmental data, to help monitor medication efficacy.

7. The system of claim 1, further including computer code for enabling the personalization of system communications based on one or more of personal criteria, personal behavior tracking, tracking of user physiological element(s), and tracking of environmental element(s).

8. The system of claim 6, wherein said personal user behavior tracking includes medication related gesture tracking based on one or more movement sensors.

9. The system of claim 1, further including predictive algorithms to enable enhanced alerting of users based on predictions of likely non-adherence.

10. The system of claim 1, wherein the sensors are selected from the group consisting of wearables sensors, connected devices, mobile device sensors, and other body tracking devices used by an end user.

11. A platform for social medication management, comprising:
a social media enabled website and medicine adherence services with social media network functionality;
a mobile computing device enabled with an medication management application including a virtual pill box, the mobile device being connected to one or more sensors for tracking medication adherence related data;
a medication adherence database; and
a group management portal for enabling user medication management data with a selected social group.

12. The platform of claim 11, further comprising connectivity to one or more third party modules.

13. The platform of claim 11, further comprising a data security module.

14. The platform of claim 11, further comprising a group alert module for alerting a selected social group of an event.

15. The platform of claim 11, further comprising a gesture tracking module and one or more movement sensors.

16. A method for enabling social medication adherence, comprising:
installing a medication adherence application to a mobile communications device, where the medication adherence application is enabled to display and operate a virtual pill box;
communicatively connecting the medication adherence application to a medication adherence management platform;
setting up a social group connected to a user via the platform, to help monitor user medication adherence;
adding user medication adherence data into the platform, via the application, wherein the user medication adherence data includes data from one or more sensors communicatively connected to the communications device; and
tracking medication adherence of a user, by the social group.

17. The method of claim 16, further comprising synchronizing the medication adherence data between the social group.

18. The method of claim 16, further comprising cross checking medication data on the medication adherence management platform with user medication adherence data from the medication adherence application.

19. The method of claim 16, further comprising automatically tracking user movement to identify medication adherence behaviour.
